(19) United States
(12) Patent Application Publication
(10) Pub. No.: US 2002/0076134 A1
(43) Pub. Date: Jun. 20, 2002

(54) Methods and apparatuses for optical switches

(76) Inventor: Navrit P. Singh, Milpitas, CA (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/021,399

(22) Filed: Dec. 12, 2001

Related U.S. Application Data
(60) Provisional application No. 60/256,059, filed on Dec. 15, 2000.

(51) Int. Cl. G02B 6/35; G02B 6/26

(52) U.S. Cl. 385/16; 385/25

(57) ABSTRACT

Optical switches and other similar optical configurations can comprise high-speed, high precision motors such as voice coil motors to carry out optical switching for applications such as optical signal based communication systems. These switches and configurations are expected to have switch time delays per channel that are significantly shorter than conventional optical switches. Some embodiments may have switch time delays that may be about a factor of 10 (or more) shorter than that for the conventional optical switch technology. Some embodiments may optimize optical coupling efficiency to increase the optical signal intensity transmission through optical switches and potential extend the useful life of the optical switches.

### RELATED APPLICATIONS

This application claims priority under 35 U.S.C. §119(e) to U.S. Patent Application No. 60/256,059 entitled “Methods and Apparatus for Optical Switching” by Singh filed Dec. 15, 2000, which is assigned to the current assignee hereof and is incorporated herein by reference.

### FIELD OF THE INVENTION

This invention relates in general to optical switches and configurations, and more particularly, to optical switches and configurations and methods for optimizing optical signals transmitted through optical switches and configurations.

### DESCRIPTION OF THE RELATED ART

Optical switches and interconnects are relatively new devices used primarily in the communications industry. They are primarily used for optical networks and for optical network testing and measurements. Many optical switches and interconnects include mechanical mechanisms that move in linear directions to align optical elements. A typical configuration for a standard switch results in an undesirably long switch delay time of approximately 10 ms per channel.

Optical switches and interconnects typically use mechanical mechanisms to align optical elements. In addition, the standard switch technologies tend to have problems with repeatability and optical alignment for the switching.

Further, conventional optical switches are subject to irreversible degradation. For example, optical signal intensity transmission through a new optical switch may be approximately 90% and will never improve. Due to wear and other environmental conditions, the optical signal intensity transmission through that same switch may be approximately 50% at a time in the future. Typically, detection of a connection occurs if the optical signal intensity at a channel is at least 50% of the optical signal intensity received by the switch. If three optical switches are connected in series and each optical switch allows approximately 50% of the incoming light intensity to be transmitted, the optical signal intensity out of the three-switch combination can be a little more than 10% of the original optical signal intensity.

Numerous applications need reliable and efficient methods and apparatuses for optical switching. Unfortunately, the conventional methods and apparatuses have characteristics that may be unsuitable for meeting the requirements for rapid, reliable, and economical switches.

### SUMMARY OF THE INVENTION

Optical switches and configurations and methods of using them can overcome the problems with slow switching speeds and degradation seen with conventional switches. In some embodiments, angular motion, as opposed to straight-line motion, may be used to speed switching times. Further, optical coupling efficiency may be optimized and improve the transmission of light intensity through the switch and significantly increase the lifetime of the optical switch. Skilled artisans appreciate that all of these various aspects are not required by each of the appended claims.

In one set of embodiments, an optical switch can comprise an optical component and an actuator coupled to the optical component. The actuator can be adapted to provide angular motion to the optical component. In another set of embodiments, an optical switch can comprise an optical component and a voice coil motor coupled to the optical component. The voice coil motor can be adapted to move the optical component.

In still another set of embodiments, a method of transmitting an optical signal through an optical switch can comprise moving an optical component to direct a path for the optical signal to a location near the first optical receiver and, after moving the optical component, increasing an optical coupling efficiency between the optical component and the first optical receiver.

In yet another set of embodiments, an optical configuration can comprise an optical component, an optical receiver, a semi-reflective film, and an optical tap. The optical receiver can be configured to receive a substantial portion of an optical signal from the optical component. The semi-reflective film may lie between the optical component and the optical receiver. The optical tap can be configured to receive a significant portion of the optical signal that is reflected from the semi-reflective film.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures, in which:

FIGS. 1-4 include schematic diagrams of different embodiments of optical switches.

FIG. 5 includes an illustration of a perspective view of an embodiment an optical switch that comprises a voice coil motor and a prism.

FIG. 6 includes an illustration of a top view of an embodiment of an optical switch that has an optical tap configuration.

FIG. 7 includes an illustration of a cross-sectional view of the optical tap configuration in FIG. 6.

FIGS. 8 and 9 includes a flow chart for increasing the optical coupling efficiency for an optical switch.

FIG. 10 includes an illustration of a perspective view of another optical switch.

FIG. 11 includes an illustration of a cross-sectional view of an alternative embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

Optical switches and other similar optical configurations can comprise high-speed, high precision motors such as voice coil motors to carry out optical switching for applications such as optical signal based communication systems. These switches and configurations are expected to have (1) switch time delays per channel that are significantly shorter than conventional optical switches; (2) insertion losses (loss of transmitted signal power) that are significantly lower than those of other technologies; and (3) higher repeatability. Some embodiments may have switch time delays that may be about a factor of 10 (or more) shorter than that for the conventional optical switch technology. Some embodiments may optimize optical coupling efficiency to increase the optical signal intensity transmission through optical switches and potential extend the useful life of the optical switches.

Before describing specific embodiments, “light,” “optical,” and their variants are defined as including photons or radiation at any wavelength, including radiation outside the visible spectrum. Therefore, “light” or “optical” may include infrared, ultraviolet, x-ray or other wavelengths of radiation. “Visible” is used to limit “light,” “optical,” or their variants to the visible light spectrum. “Light,” “optical,” and their variants do not include electrons.

FIG. 1 includes a diagram of an optical switch 100. Optical switch 100 can comprise an optical component 105, light receivers 110, voice coil motor 115, and controller 120. In optical switch 100, the optical component 105 can direct an optical signal toward any of light receivers 110. Light receivers 110 include at least one individual light receiver (not shown in FIG. 1) for receiving optical signals transmitted from optical component 105. An on-off switch would be one type of switch that would have only one individual light receiver. In other embodiments, light receivers 110 include more than one individual light receiver (not shown in FIG. 1). The individual light receivers in light receivers 110 can be arranged so that optical signals from optical component 105 can be switched to any of the individual light receivers or to none of the individual light receivers.

Optical component 105 can be coupled to voice coil motor 115 so that optical component 105 can be moved using voice coil motor 115 to direct optical signals selectively to individual light receivers in light receivers 110. Controller 120 is coupled to voice coil motor 115 to control movement of voice coil motor 115. Voice coil motors are conventional and commonly used in disk drives of computers. Voice coil motor 115 can be designed to provide linear motion, radial motion or rotary motion. In some embodiments, voice coil motor 115 produces radial or rotary motion sufficient to direct optical signals to any or none of the individual light receivers in light receivers 110. In other embodiments, voice coil motor 115 produces linear motion sufficient to direct optical signals to any or none of the individual light receivers in light receivers 110.

Voice coil motor 115 provides significant advantages. Voice coil motor technology is well known, well understood, and commonly used. Therefore, the use of voice coil motors in optical switches is expected to be highly reliable. Another advantage is that many of the key parts are based on readily available technology. In addition, voice coil motor technology is known to have rapid response times. As such, optical switches with voice coil motors are expected to have switching times per channel faster than the conventional technology. The switching time per channel should be in a range of approximately 10-1000 microseconds, and more commonly in a range of approximately 50-100 microseconds. Further, voice coil motors are good for actuating radial motion (i.e., motion that is part of a complete rotation, for example, no more than approximately a 90° sweep) or rotary motion (e.g., motion that can make a substantially complete rotation). More specifically, the coil for the voice coil motor is typically part of an arm assembly. The arm can be an actuator for providing angular motion to the optical component 105. The benefit of angular motion is described later in the specification.

Optical component 105 can be any of the numerous types of optical components capable of transmitting optical signals. Typically, the types of optical components are those in common use for optical signal communication and optical signal information processing. Some examples of the types of optical components for optical component 105 in this particular embodiment are optical fibers and electronic lasers. In this example, the optical component 105 may be the item that is physically carrying the light (optical fiber) or a source of the light (electronic laser).

Light receivers 110 can be any one of numerous types of optical elements capable of receiving optical signals. Typically, the types of receivers are those in common use for optical signal communication and optical signal information processing. Some examples of the types of receivers for light receivers 110 are optical fibers, prisms, photoelectronic detectors, and the like. In a specific embodiment, light receivers 110 include one or more optical fibers arranged to receive light from optical component 105.

Optionally, controller 120 may be used for providing control signals to voice coil motor 115. Specifically, controller 120 may provide the signals instructing voice coil motor 115 to move so that optical component 105 can selectively switch optical signals to or between the receivers in light receivers 110. In another embodiment, controller 120 may be remotely located from the optical switch. In this embodiment, the combination of the controller 120 and optical switch is an optical switching system.

Optical switch 100 may be mounted on a base plate (not shown in FIG. 1). Alternatively, optical switch 100 may be mounted substantially within a housing (not shown in FIG. 1) similar to those used for containing conventional optical switches or those used for disk drives.

FIG. 2 includes a diagram of optical switch 200 with a different configuration. Optical switch 200 includes light receivers 110, voice coil motor 115, and controller 120 that are substantially the same as those previously described. Optical switch 200 can further include light source 225. Light source 225 may be used when optical component 205 is a mirror, prism, lens, collimator, any combination thereof, or the like. Unlike the optical component 105 in FIG. 1, optical component 205 does not have a “tether” or other motion restraining or slowing feature (e.g., optical fiber) or the size or mass of an electronic laser. Therefore, the switching time per channel for optical switch 200 should be less than the switching speed per channel for optical switch 100.

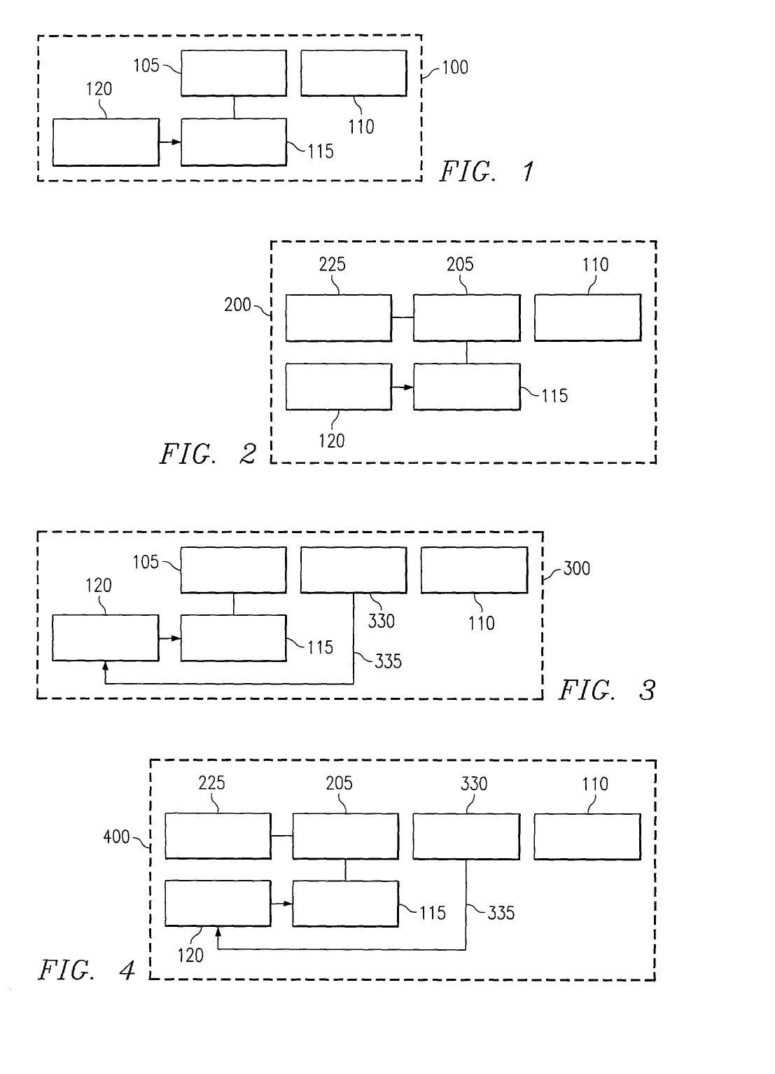

FIG. 3 includes a diagram of optical switch 300, which includes optical component 105, light receivers 110, voice coil motor 115, and controller 120 that are substantially the same as those described with respect to FIG. 1. Optical switch 300 can further comprise a detector 330, which can be used to determine the optical coupling efficiency between optical component 105 and light receivers 110. Detector 330 provides information 335 that is representative of the optical coupling efficiency to controller 120. Controller 120 uses information 335 to adjust the position of optical component 105 so as to achieve a desired or optimum optical coupling efficiency between optical component 105 and light receivers 110. Although detector 330 is shown in the schematic diagram to be located between optical component 105 and light receivers 110, this is not a required location for detector 330. Detector 330 may be disposed in any suitable manner that allows monitoring the optical coupling efficiency between optical component 105 and light receivers 110. For example, in an alternative embodiment (not shown in FIG. 4), detector 330 may be configured to receive tap signals from light receivers 110. In yet another embodiment (not shown in FIG. 4), detector 330 may be attached to the assembly holding optical component 205. After reading the specification, skilled artisans appreciate that still other configurations are possible.

Unlike the conventional optical switch technology, the embodiment illustrated in FIG. 3 has additional active control capabilities for obtaining accurate and reliable optical switching and to reduce light intensity loss through the optical switch 300. Specifically, a close loop control system responsive to active measurements of the optical coupling efficiency may be used to optimize coupling efficiency for any or all switching sequences. Therefore, the embodiment in FIG. 3 is expected to have optical alignment and signal carrying capabilities that are superior to those of the conventional optical switch technology.

FIG. 4 includes an illustration of optical switch 400, which has many of the attributes of optical switches 100, 200 and 300 illustrated in FIGS. 1, 2 and 3. Optical switch 400 includes light receivers 110, voice coil motor 115, controller 120 as described with respect to FIG. 1. Optical switch 400 further includes light source 225 and optical component 205 as described with respect to FIG. 2 and detector 330 and feedback loop 335 with respect to FIG. 3. Optical switch 400 in FIG. 4 is expected to have the additional optical component selection options as described with respect to FIG. 2 and the additional control capabilities as described with respect to FIG. 3.

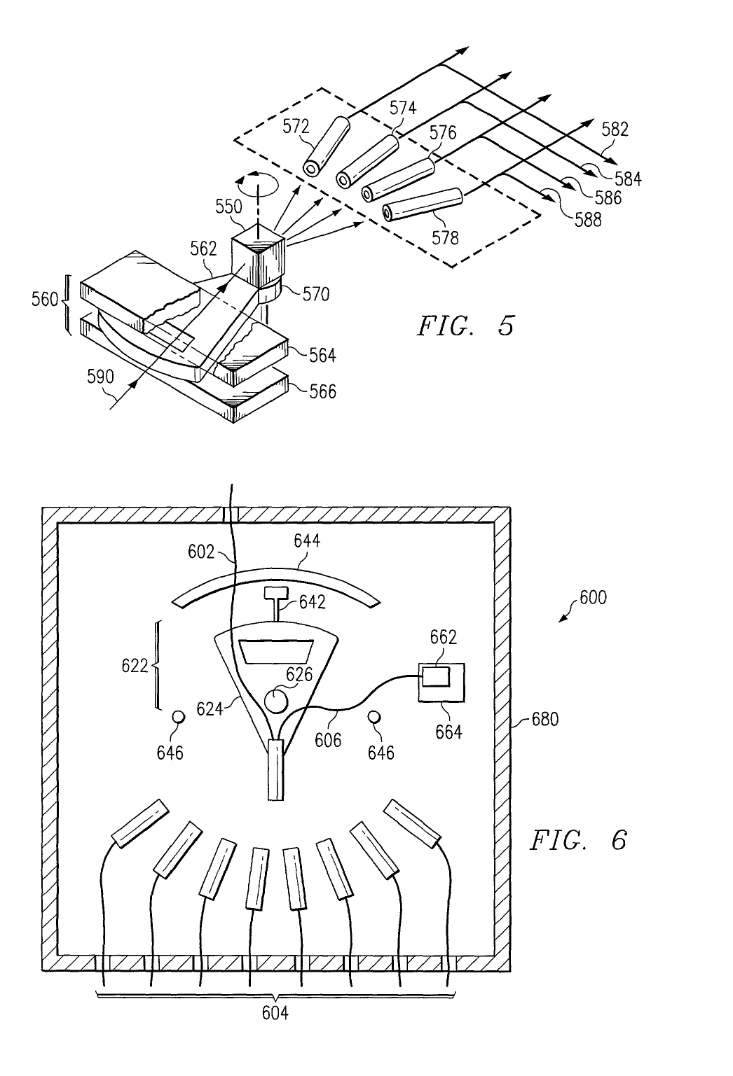

FIG. 5 includes a perspective view of an embodiment illustrating the relationships between prism (optical component) 550, voice coil motor 560, a pivot bearing 570, and an array of optical fibers (optical receivers) 572, 574, 576, and 578. Voice coil motor 560 includes coil 562 and permanent magnets 564 and 566 in a conventional arrangement for a rotary motion voice coil motor similar to that commonly used in a disk drive.

Voice coil motor 560 is rotatably coupled to pivot bearing 570 to allow rotary motion about pivot bearing 570. Prism 550 is coupled to voice coil motor 560 so that voice coil motor 560 causes prism 550 to rotate during a switching sequence. A controller (not shown in FIG. 5) can provide the control signals for voice coil motor 560. A light source 590 is spaced apart from voice coil motor 560 and arranged to provide optical signals to prism 550. Prism 550 is arranged to selectively direct optical signals toward any of the optical fibers 572, 574, 576, and 578 to receive the optical signals. Optical fibers 572, 574, 576, and 578 can be arranged to be substantially co-planar along an arc.

The optical switching process can include directing light from light source 590 towards prism 550. Prism 550 receives the light and directs the light towards a selected one of optical fibers 572, 574, 576, and 578. The selection of a particular optical fiber is accomplished by causing voice coil motor 560 to rotate prism 550 so that light directed from prism 550 reaches the selected optical fiber.

FIG. 5 also shows that optical fibers 572, 574, 576, and 578 can have branching optical fibers (optical taps) 582, 584, 586, and 588, respectively, that are designed to split off or tap a percentage of the optical signal transmitted from prism 550 and received by the respective optical fibers 572, 574, 576, and 578, respectively. The tap signals, through branching optical fibers 582, 584, 586, and 588, can be used to determine optical coupling efficiency between prism 550 and optical fibers 572, 574, 576, and 578. Optical coupling efficiency information from the tap signals can be provided to the controller (not shown in FIG. 5) for controlling voice coil motor 560. Therefore, the controller can provide closed-loop feedback control of the optical alignment during the switching process. Additional motion of the voice coil motor can optimize the light (minimize loss of light intensity) transmitted to any of the optical fibers 572, 574, 576, and 578 to complete the switching process.

The maximum tap signal intensity should be less than about 50 percent of the total signal intensity transmitted from prism 550 and received by optical fibers 572, 574, 576, and 578. Usually, the maximum tap signal is less than approximately 5 percent of the total signal through optical fibers 572, 574, 576, and 578. Often, the maximum tap signal is approximately 2 percent of the total signal through optical fibers 572, 574, 576, and 578.

Reference is now made to FIG. 6, which includes a cross-sectional view of an illustration of optical switch 600. Optical switch 600 includes housing 680, input optical fiber 602, voice coil motor 622, pivot bearing 626, and a plurality of optical fibers 604. Housing 680 contains voice coil motor 622 that can include coil (actuator) 624 and permanent magnets (not shown in FIG. 6) set in a standard arrangement for a rotary motion voice coil motor similar to that commonly used in disk drives.

Voice coil motor 622 is rotatably coupled to pivot bearing 626 to allow angular motion or rotation about pivot bearing 626. Input optical fiber 602 passes through a wall of housing 680 and is connected to coil 624 so that rotary motion of voice coil motor 622 can move input optical fiber 602 during a switching sequence. Typically, a controller (not shown in FIG. 6) provides control signals for voice coil motor 622. Input optical fiber 602 is arranged to selectably direct optical signals to one of optical fibers 604, so that it receives the optical signals. In many embodiments, optical fibers 604 pass through housing 680. Furthermore, the ends of optical fibers 604 are coupled to housing 680 so that the ends of optical fibers 604 are held substantially stationary with respect to housing 680. Typically, optical fibers 604 can be arranged to lie substantially along the same plane.

The embodiment shown in FIG. 6 can further include a photosensor 642 connected with coil 624 of voice coil motor 622 so that photosensor 642 moves during the switching sequence. An array of LEDs 644 is arranged near photosensor 642 so that photosensor 642 can be used to derive positional information by detecting any one or more of the LEDs in array of LEDs 644. In an alternative embodiment (not shown), a movable photodiode may be used and an array of photo detectors can be used. Photo transistors and other optical conversion sensors can be used in alternative embodiments.

Optical switch 600 can further comprise optical tap 606 that includes an optical fiber for transmitting a portion the signal from input optical fiber (optical component) 602 to a photodiode (optoelectronic component) 662. The photodiode 662 can convert the optical signal to an electronic signal that printed circuit board 664 can use as part of a feedback loop to optimize or otherwise increase the optical coupling efficiency between the optical fibers 602 and 604. A method of using the optical tap 606 will be subsequently described with respect to FIGS. 8 and 9.

FIG. 6 can also include two hard stops 646. Usually, hard stops 646 are substantially rigid structures connected with housing 680. Hard stops 646 are arranged to limit the range of motion of actuator arm 624.

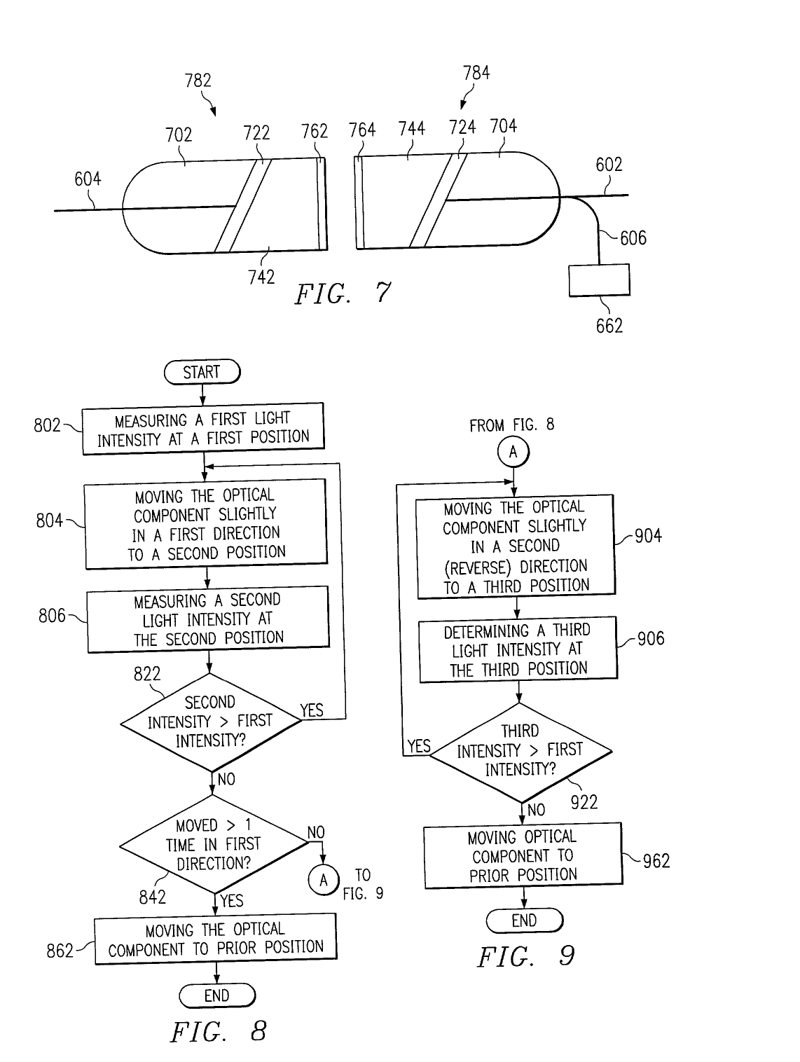

FIG. 7 includes an illustration of a cross-sectional view illustrating the optical tap arrangement (optical configuration) from FIG. 6 used for controlling switching and optimizing or otherwise increasing optical coupling efficiency. FIG. 7 illustrates two fittings 782 and 784, which can include ferrule 702 and ferrule 704. Ferrule 702 can hold an end of optical fiber 604 in place, and ferrule 704 can hold ends of optical fibers 602 and 606 in place. In this embodiment, the ends of input and output optical fibers 602 and 604 are spaced apart from each other substantially facing each other, and the ends of input optical fiber 602 and optical tap 606 substantially face the same direction.

The optical fiber 604 may be attached to gradient index (“GRIN”) lens 742 with epoxy 722 or other attaching material. Similarly, optical fibers 602 and 606 may be attached to GRIN lens 744 with epoxy 724 or other attaching material. Alternatively, GRIN lenses 742 and 744 may be held in place by the fittings 782 and 784, and epoxy 722 and 724 may be replaced by air gaps.

Antireflective film 764 lies at the opposite side of GRIN lens 744 compared to optical fibers 602 and 606, and semi-reflective film 762 lies at the opposite side of GRIN lens 742 compared to optical fiber 604. An air gap lies between films 762 and 764. The size of the air gap typically depends on the size of the fittings and amount of the signal to be reflected back to optical tap 606. Typically, the air gap may be in a range of approximately 100 microns to 5 millimeters. A smaller air gap typically gives better performance. However, enough space should be allotted for movement of parts within the housing 680 without films 762 and 764 contacting each other.

Attention is now directed to films 762 and 764 and the operation of the optical configuration shown in FIG. 7. An optical signal at a first light intensity is transmitted through optical fiber 602 to optical fiber 604. A small portion of the optical signal is reflected by semi-reflective film 762 back to optical fiber 606. Films 762 and 764 typically have a composition different from their adjacent GRIN lenses 742 and 744, respectively. Films 762 and 764 are typically an oxide, a nitride, or a combination thereof. Some examples of the materials for films and 764 include silicon nitride, titanium dioxide, tantalum nitride, other refractory metal oxides or nitrides, combinations thereof, or the like. Films 762 and 764 may have compositions that are the same or different from each other.

The amount or lack of reflection by films 762 and 764 can be adjusted by controlling the thickness of films 762 and 764. The thickness of film 764 should be selected to minimize reflection. In other words, reflection should be as close to zero as reasonably possible. The thickness of film 762 should be selected to allow a relatively small fraction of light to be reflected. Typically, the amount of reflection of the light from optical fiber 602 should be in a range of approximately 0.2 to 5.0 percent and more commonly in a range of approximately 0.5 to 1.5 percent. Ideally, the amount of reflection may be approximately 1.0 percent. By knowing the composition of the films 762 and 764 and the amount of light, if any, to be reflected, skilled artisans may use conventional method(s) to determine the thicknesses films 762 and 764.

The use of GRIN lenses 742 and 744 is not required. Other optically transparent objects may be used. The surfaces of that other optically transparent objects near films 762 and 764 should be substantially flat. In this manner, each of films 762 and 764 can be substantially flat, uniformly thick, and perpendicular to the lengths of fibers 602, 604, and 606 within the fittings 782 and 784 and to the light paths using the optical configuration shown in FIG. 7.

The optical configuration of FIG. 7 may allow up to 99% of the intensity of the optical signal from optical fiber 602 to be transmitted to optical fiber 604. Reflected light may enter optical tap 606, which is also an optical fiber, that is fed into photodetector 662. Photodetector 662 can convert a light signal from optical tap 606 to an electronic signal. The electronic signal can be sent to the controller (not shown in FIG. 6) that is used to control voice coil motor 622 and the position of the coil 624. More details of a switching sequence including optimizing optical coupling efficiency are described with respect to FIGS. 8 and 9 that are later in the specification. Higher amounts of transmission through the optical switch may be possible if the semi-reflective film 762 reflects less light. The optical configuration allows fiber-to-fiber optical alignment to be used.

Unlike conventional switches, embodiments can be used to increase the optical coupling efficiency between an optical component and an optical receiver even after an optical connection has been made. In one specific embodiment, information may be transmitted through the optical switch while increasing the optical coupling efficiency. FIGS. 8 and 9 include a flow diagram illustrating a method of switching and optimizing the light intensity transmission through the switch. Reference may be made to FIGS. 6 and 7, as appropriate. Fiber-to-fiber optical alignment can be performed as described herein.

Initially, the light path through optical switch 600 may be directed to one of optical fibers 604. Optical switch 600 may be used to re-direct the path for the optical signal from one of optical fibers 604 to a different optical fiber 604 by moving coil 624, and hence, moving optical fiber 602, which is referred to as optical component 602 in this example. After moving the light path to the other optical fiber 604, the method can further comprise increasing the optical coupling efficiency between the optical component (optical fiber 602) and the optical receiver (optical fiber 604). Much of the focus in FIGS. 8 and 9 is related to increasing optical coupling efficiency in accordance with some non-limiting exemplary embodiments.

Referring to FIG. 8, the method can comprise measuring a first light intensity at a first position for the selected optical fiber 604 (block 802). The light intensity can be measured from the optical tap 606 and converted to an electronic signal within photodetector 662. Note that the light intensity may be higher than the minimum threshold intensity corresponding to an optical connection between the optical fibers 602 and 604. For example, the minimum optical connection may be considered to be made when the optical tap 606 provides enough light to indicate that at least 50% of the light intensity in optical fiber 602 is received by optical fiber 604. Although 50% transmission may be sufficient for an optical connection, a higher level of transmission through the optical switch is desired.

The method can further comprise moving optical component 602 slightly in a first direction from a first position to a second position (block 804). High precision movement is capable with voice coil motor 622. The movement is typically a relatively small fraction of the distance needed to move from channel to channel. The amount of movement can be a known amount, a measured step, or an arbitrary distance. The method can also include measuring a second light intensity at the second position (block 806).

A first decision diamond 822 illustrates a decision to determine whether the second intensity is equal to or greater than the first intensity. In one embodiment, the determination may be performed by subtracting the first intensity from the second intensity. If “YES”, the method continues with an iterative loop going back to block 804. The original second intensity and original second position are treated as the first intensity and first position, respectively, and the new intensity and new position are treated as the second intensity and second position, respectively, for the purposes of the flow chart. The loop is continued until the condition is no longer true (“NO”).

A second decision diamond 842 illustrates a decision to determine if optical component 602 was moved more than one time in that same (first) direction. If so (“YES”), a maximum intensity was reached. The method can comprise moving the optical component 602 to the prior position (block 862) where the maximum occurred.

If the intensity of the light is diminishing after even the one move in the first direction (“NO” branch from diamond 842), the first direction is the wrong direction to maximize the light intensity. Turning to FIG. 9, the method can further comprise moving optical component 602 in a second (reverse) direction to a third position (block 904). The method can comprise measuring a third light intensity at the third position (block 906). A third decision diamond 922 illustrates a decision to determine whether the third intensity is greater than the first intensity. If so (“YES”), the method continues with block 904. The iterative loop can continue until the condition is no longer true (“NO”). The method can then comprise moving optical component 602 to the prior position (block 962) where the maximum may have occurred.

Other alternative methods may be used. For example, if the first and second intensities are substantially the same, the optical component 602 can be kept at the second position. Alternatively, a maximum intensity may occur between the first and second positions. In this situation, the optical component 602 may be positioned between the first and second positions. In some instances, the first position may be the maximum, in which case, the optical component 602 could start out and end up at the first position.

In still another embodiment, the method can be extended in other directions. The first and second directions may lie substantially along the same plane and can be characterized as arcs. When extended, the method can comprise moving optical component 602 along the third and fourth directions that lie substantially along a different plane. The third and fourth directions may lie along a plane that is substantially perpendicular to first plane. Also, the third and fourth directions may be linear or along arcs similar to the first and second directions. In one specific example, the first and second directions may be used to control horizontal position and the third and fourth directions may be used to control vertical position of optical component 602. Therefore, the method can comprise optimizing the optical coupling by moving optical component 602 substantially along the first plane and moving optical component 602 along a second plane that is not parallel to the first plane.

The light intensity plotted as a function of distance along a planar arc can be a Gaussian distribution. Optimization may be quicker if a movement is based on a derivative value (change in light intensity/change in distance (or angle) moved). Other methods for optimizing may include proportional or integral control typically used in instrumentation control (temperature control, flow control, etc.). Combinations of proportional, integral, and derivative control can be used to quickly optimize without significant overshoot and with good damping characteristics.

In contrast, a conventional rectilinear arrangement of optical fibers within an optical switch can generate a square wave, not a Gaussian distribution. Optimizing optical coupling of light can be difficult, if not impossible, with such an arrangement. The rectilinear arrangement can lead to optical signal misalignments followed by power losses.

Since the dynamic light and power attenuation by means of radial alignment of fibers yields a nearly ideal Gaussian distribution, the dynamic gain equalization locus of power against time, yields a substantially straight line. Substantially equalized gain is typically not possible with a linear switch. Equalized gain can be an important parameter in testing the sensitivity of devices and another distinction of the embodiments using rotary or radial motion.

The nearly ideal Gaussian distribution of the transmitted signal power can be utilized to attenuate the transmitted power to any desired level between zero and 100%. Thus, the radial alignment scheme also provides a means for variable optical attenuation of the signal, without introducing any additional insertion losses. The nearly ideal Gaussian distribution of the transmitted signal power can be utilized to integrate other features that may rely on such a distribution

The dynamic gain equalization made possible by radial alignment of sending and receiving fibers with the closed-loop feedback control system can be important for broadcast devices because it can eliminate power fluctuation and subsequent feedback repercussions.

The optimization portion helps to optimize light intensity transmitted and reduce light intensity losses when passing through switches. If an optical switch is optimized to transmit 95% of the incident light intensity (coming into the optical switch), three optical switches connected in series will have an output light intensity of approximately 85% (0.95³×100%). At 99% transmission, the output light intensity increases to approximately 97% transmission through the three optical switches connected in series. Compare to the conventional binary method where approximately 13% of the original light intensity may be transmitted through the three serially connected optical switches. Note the methods described herein may achieve the maximum amount of optical coupling efficiency, however, none of the methods require that the maximum be reached.

The optimization allows for corrections to environmental conditions including the gradual degradation of moving parts, humidity, and other factors that may effect transmission of the light signal through the optical switch. Also, the method makes possible fiber-to-fiber alignment for fibers that are no more than approximately one micron in diameter (width).

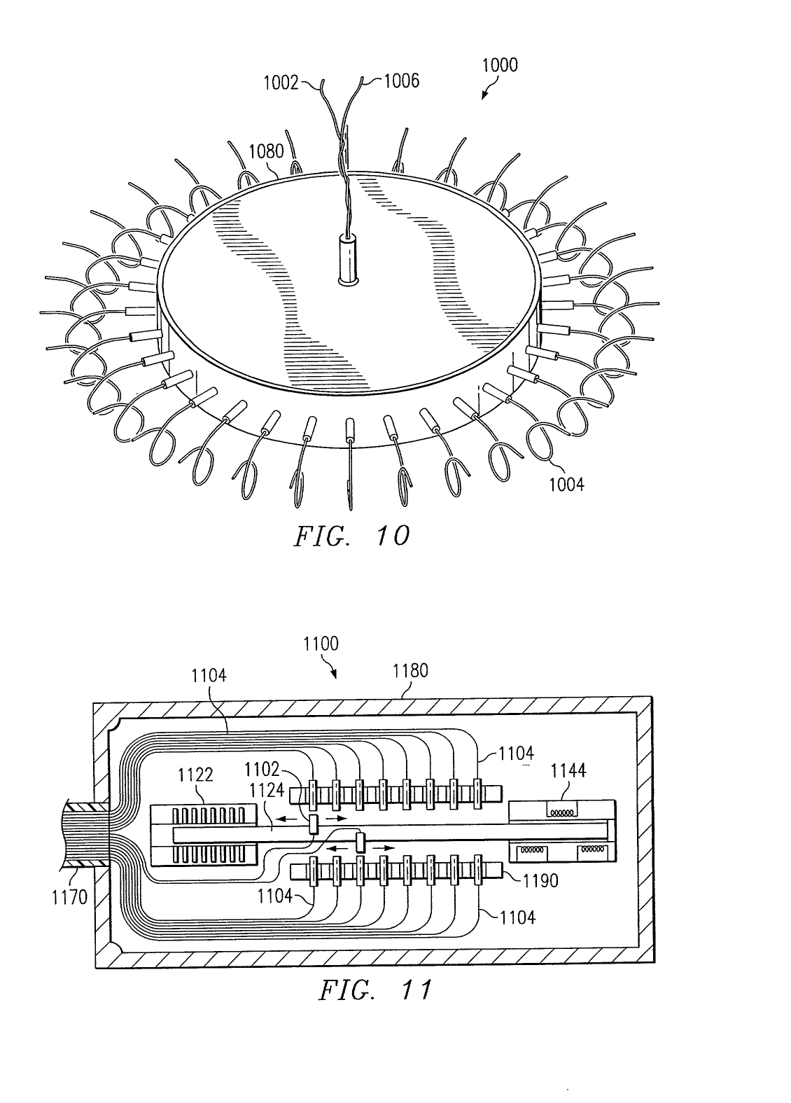

FIG. 10 includes an illustration of an isometric view of a rotary configuration. This arrangement is rotatably coupled to feed a source signal from input optical fiber 1002 extended through the housing from a central position from which the tap optical fiber 1006 also protrudes in parallel. The receiver optical fibers 1004 are radially aligned at intervals along the circumference. The receiver optical fibers 1004 can be output channels when engaged with the input optical fiber 1002. The internal configuration may be modified from the embodiments illustrated in FIGS. 5 and 6. After reading this specification, skilled artisans can determine an internal configuration suited for their particular needs.

FIG. 11 includes a cross-sectional view of optical switch 1100 that can selectably switch optical signals from one or more input optical fibers to one or more receiving optical fibers. In this particular embodiment, optical switch 1100 can be a 2×16 optical switch. Optical fiber bundle 1170 connected to housing 1180 of optical switch 1100. Housing 1180 may contain two input optical fibers 1102, 16 receiver optical fibers 1104, linear motion voice coil motor 1122, drive shaft 1124, linear variable differential transformer LVDT 1144 that can function as an encoder, and output lens post-1190. In many embodiments, the ends of optical fibers 1104 that receive optical signals are coupled to housing 1180 using output lens post 1190 so that the ends of optical fibers 1104 maintain a substantially fixed position with respect to motion of drive shaft 1124.

Voice coil motor 1122 can move drive shaft 1124 forward and backward in response to electrical signals applied to voice coil motor 1122. Input optical fibers 1102 are connected to drive shaft 1124 so that movement of the drive shaft causes input optical fibers 1102 to be selectably switched between optical fibers 1104.

Linear variable differential transformer 1144 is optional. Transformer 1144 can function as an encoder for keeping track of and controlling the position of input optical fibers 1102 during a switching sequence. The principles of operation of transformer 1144 are well known by skilled artisans.

Drive shaft 1124 and transformer 1144 are arranged so that drive shaft 1124 can move further in or out of transformer 1144. Drive shaft 1124 is made of a suitable conducting material so that movement of drive shaft 1124 and transformer 1144 generates a detectable voltage that is measurable. The voltage has a precise relationship to the movement of the drive shaft. The voltage measurements can be used to determine the position of the drive shaft and to determine and control the amount of movement of the optical fibers as part of the switching process.

Many different optical switch configurations are possible. To list every possible embodiment would be nearly impossible. However, some further embodiments are mentioned. A shutter mechanism or other optical attenuator may be used as the optical component. A variable optical attenuator can be used to control the transmission of the optical signal though an optical switch.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited only to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. An optical switch comprising:
an optical component; and
an actuator coupled to the optical component, wherein the actuator is adapted to provide angular motion to the optical component.

2. The optical switch of claim 1, further comprising a plurality of optical receivers including a first optical receiver, wherein the actuator is configured to direct a signal from the optical component to the first optical receiver.

3. The optical switch of claim 2, further comprising a controller coupled to the actuator.

4. The optical switch of claim 3, further comprising a feedback loop, wherein:
the feedback loop includes an optoelectronic component that is adapted to receive a portion of an optical signal from the optical component and convert that portion to an electronic signal; and
the optoelectronic component is coupled to the controller.

5. The optical switch of claim 1, wherein the actuator is part of a voice coil motor.

6. The optical switch of claim 1, wherein the optical component comprises an optical fiber or an electronic laser.

7. The optical switch of claim 1, wherein the optical component comprises a mirror or a prism.

8. The optical switch of claim 1, wherein the optical component comprises a lens or a collimator.

9. An optical switch comprising:
an optical component; and
a voice coil motor coupled to the optical component, wherein the voice coil motor is adapted to move the optical component.

10. The optical switch of claim 9, further comprising a plurality of optical receivers including a first optical receiver, wherein the voice coil motor is configured to direct a signal from the optical component to the first optical receiver.

11. The optical switch of claim 10, further comprising a controller coupled to the voice coil motor.

12. The optical switch of claim 11, further comprising a feedback loop, wherein:
the feedback loop includes an optoelectronic component that is adapted to receive a portion of an optical signal from the optical component and convert that portion to an electronic signal; and
the optoelectronic component is coupled to the controller.

13. The optical switch of claim 9, wherein the optical component is configured to rotate about an axis.

14. The optical switch of claim 9, wherein the optical component comprises an optical fiber or an electronic laser.

15. The optical switch of claim 9, wherein the optical component comprises a mirror or a prism.

16. The optical switch of claim 9, wherein the optical component comprises a lens or a collimator.

17. The optical switch of claim 9, further comprising:
an array of optical receivers oriented substantially along a plane, wherein the array of optical receivers includes a first optical receiver;
a controller coupled to the voice coil motor; and
an optoelectronic component that is adapted to receive a portion of an optical signal from the optical component and convert that portion to an electronic signal,
wherein the optical component and optical receivers are optical fibers.

18. The optical switch of claim 17, further comprising:
a first fitting for holding a portion of the optical component and an optical tap, wherein the first fitting includes an antireflective film lying between the optical component and the first optical receiver; and
a second fitting for holding a portion of the first light receiver, wherein the second fitting includes a semi-reflective film lying between the antireflective film and the first optical receiver.

19. A method of transmitting an optical signal through an optical switch comprising:
moving an optical component to direct a path for the optical signal to a location near the first optical receiver; and
after moving the optical component, increasing an optical coupling efficiency between the optical component and the first optical receiver.

20. The method of claim 19, wherein increasing the optical coupling efficiency further comprises:
measuring a first light intensity at a first position;
moving an optical component in a first direction from the first position to a second position;
measuring a second light intensity at the second position; and
comparing the first and second light intensities to each other.

21. The method of claim 20, wherein:
the first intensity is greater than the second intensity; and
increasing the optical coupling efficiency further comprises moving the optical component from the second position to the first position.

22. The method of claim 20, wherein:
the first intensity is greater than the second intensity; and
increasing the optical coupling efficiency further comprises moving the optical component from the second position to a third position in a second direction opposite the first direction, wherein the first position lies between the second and third positions.

23. The method of claim 20, wherein the first intensity is equal to or less than the second intensity, and wherein the optical component remains substantially at the second position.

24. The method of claim 20, wherein:
the first intensity is equal to or less than the second intensity; and
increasing the optical coupling efficiency further comprises moving the optical component from the second position to a third position in the first direction, wherein the second position lies between the first and third positions.

25. The method of claim 20, wherein the first direction is characterized as an arc.

26. The method of claim 19, wherein increasing the optical coupling efficiency further comprises:
moving the optical component along a first plane; and
moving the optical component along a second plane that is not parallel to the first plane.

27. The method of claim 26, wherein the first and second planes are substantially perpendicular to each other.

28. The method of claim 19, further comprising measuring a first light intensity after moving the optical component and before increasing the optical coupling efficiency, wherein:
increasing the optical coupling efficiency comprises measuring a second light intensity;
the first and second light intensities are representative of an intensity of light transmitted though the optical switch; and
the first and light intensities are above a minimum threshold that corresponds to an optical connection between the optical component and the first optical receiver.

29. The method of claim 19, wherein the method is used for fiber-to-fiber optical alignment.

30. The method of claim 19, further comprising transmitting information through the optical switch during the act of increasing the optical coupling efficiency.

31. The method of claim 19, wherein moving the optical component comprises moving the optical component to re-direct the path for the optical signal from a second optical receiver to the first optical receiver.

32. An optical configuration comprising:
an optical component;
an optical receiver configured to receive a substantial portion of an optical signal from the optical component;
a semi-reflective film lying between the optical component and the optical receiver; and
an optical tap configured to receive a significant portion of the optical signal that is reflected from the semi-reflective film.

33. The optical configuration of claim 32, further comprising a first fitting and a second fitting, wherein,
within the first fitting:
the optical component is configured to transmit the optical signal to travel in a first direction;
the optical tap is configured to receive a significant fraction of the optical signal in a third direction that is substantially opposite to the first direction.
within the second fitting, the optical receiver is configured to receive a substantial fraction of the optical signal in a second direction that is substantially a same direction as the first direction.

34. The optical configuration of claim 33, wherein an air gap lies between the first fitting and the second fitting.

35. The optical configuration of claim 32, wherein:
the optical component comprises an input optical fiber having a end;
the optical receiver comprises an output optical fiber having a end, wherein the ends of the input and output optical fibers are spaced apart from each other and capable of substantially facing each other; and
the optical tap comprises a tap optical fiber having an end, wherein the ends of the input optical fiber and the tap optical fiber substantially face a same direction.

36. The optical configuration of claim 35, further comprising an antireflective film lying between the output optical fiber and the optical tap.

37. The optical configuration of claim 35, wherein:
the ends of the input optical fiber and optical tap lie within a first fitting; and
the end of the output optical fiber lies within a second fitting.

38. The optical configuration of claim 32, wherein:
a surface of the semi-reflective film faces the ends of the input optical fiber and the optical tap; and
the surface is substantially flat and substantially perpendicular to the lengths of the input optical fiber and optical tap within the configuration.

39. The optical configuration of claim 32, wherein the semi-reflective film is configured such that no more than approximately two percent of the intensity of the optical signal from the optical component is reflected by the semi-reflective film.

40. The optical configuration of claim 32, wherein the optical component and optical tap are coupled to a voice coil motor.

41. The optical configuration of claim 32, wherein the optical configuration is part of an optical switch.
